(19) United States
(12) Patent Application Publication
(10) Pub. No.: US 2011/0282747 A1
(43) Pub. Date: Nov. 17, 2011

(54) System and method for advertising

(76) Inventors: Egor Lavrov, Miami, FL (US); Anton Zingarevich, St. Petersburg (RU); Gennadiy Zingarevich, St. Petersburg (RU)

(21) Appl. No.: 13/068,433

(22) Filed: May 11, 2011

Related U.S. Application Data
(60) Provisional application No. 61/395,330, filed on May 11, 2010.

(51) Int. Cl. G06Q 30/00

(52) U.S. Cl. 705/14.64

(57) ABSTRACT

A system of the present invention provides system and method for location based advertising of goods and services provided by retailers to attract potential consumers. The system networks the retailers and the consumers subscribed to the system. A controller of the system allows the retailers to input the information about the goods and services to be sold through virtual coupons. A program of the controller is adaptable to store predetermined numerical or non-numerical identifiers with each of the identifiers representing a particular good and service of the retailer. A global positioning system is operably communicated with the controller to determine location of the consumer proximate to the retailer and electronically transmitting virtual coupon(s) to the communications device of the consumer thereby providing the consumer with option to redeem the coupon in exchange for discount or free goods and/or services at the retailer's establishment.

### RELATED APPLICATIONS

This non-provisional application claims priority to a provisional application Ser. No. 61/395,330 filed on May 11, 2010 and incorporated herewith in its entirety.

### FIELD OF THE INVENTION

The present invention relates to system and method for online advertising.

### BACKGROUND OF THE INVENTION

Advertising plays a very important part in any business trying to survive in a marketplace competing with other businesses of the kind, both existing and new established one trying to compete and even to provide new technologies, products and low process to get competitors out of business. The purpose of advertising is to promote a product and a service in the marketplace. In the past, advertising was primarily conducted in the form of television commercials, newspapers, magazines, or through advertising agents hired by various companies. These methods and techniques for advertising were limited and not effective.

Today, with advent of modern technology and particularly the use of Internet technology, online advertising became more popular. Similarly to advertising on television, newspapers, or magazines, advertisers could place solicitations on websites so that visitors to the websites would become familiar with the advertiser's product or services. The art is replete with various prior art references related to numerous systems and methods for online advertising. These prior art references include and are not limited to U.S. Pat. Nos. 7,254,547 to Beck et al., 7,376,714 to Gerken; 7,428,555 to Yan; 7,668,950 to Horowitz et al.; and United States Patent Publication No. 20090070230 to Silverstein.

The U.S. Pat. No. 7,254,547 to Beck et al. teaches a facility for providing targeted advertising messages. The facility receives advertising requests each identifying a user. For each received advertising request, the facility applies a sequence of conditions to information relating to the identified user. The facility replies to each advertising request with an advertising message associated with the first condition in the applied sequence that is satisfied. The U.S. Pat. No. 7,254,547 to Beck et al. fails to teach or suggest a method that allows any business to attract attention of a potential customer locating within the proximity of the business location or as the customer is passing by the business location.

The U.S. Pat. No. 7,376,714 to Gerken teaches a system and method for selectively acquiring and targeting online advertising inventory based on users' Internet Protocol (IP) addresses. In one aspect of the invention, Web publishers are made aware of IP addresses of interest, determined by matching attributes of current Internet users for whom IP addresses are known and targeting attributes of ad campaigns. Then, for each site visitor from one of said IP addresses, publishers choose whether to supply ad inventory to fulfill the immediate demand. Another aspect of the invention provides for targeting of online ads based on updated user IP addresses and some associated personal data provided by ISPs. The system and method also provides for a localized online advertising network in which ad inventory is selectively acquired from web sites, as required to fulfill immediate advertiser demand, and targeted by user zip code, as registered with users' ISPs.

The U.S. Pat. No. 7,376,714 to Gerken fails to teach or suggest a method that allows any business to attract attention of a potential customer locating within the proximity of the business location or as the customer is passing by the business location. The U.S. Pat. No. 7,376,714 to Gerken is directed to target online ads based on updated user IP addresses and other associated therewith personal data provided by ISPs.

Still another prior art reference, i.e. the United States Patent No. 20090070230 to Silverstein, teaches a scheme for enabling the remote purchasing of products or services based on a recipient's location. A computer-implemented method enables a purchaser to purchase a product or service for a specified recipient different from the purchaser. This method allows the purchaser to purchase at least one selected product or service for the recipient, whereby the recipient will be provided with a notification corresponding to the instruction that the product or services were purchased for him/her and where the product or the services will be provided to the recipient. The United States Patent No. 20090070230 to Silverstein fails to teach or suggest a method that allows any business to attract attention of a potential customer locating within the proximity of the business location or as the customer is passing by the business location.

In addition to the aforementioned prior art reference other prior art methods of advertising are known. For example, one online advertisement method known in the art is based on a location of a user visiting the website. This method employs a system that receives content of the information, determining an ad context from the content, determines a geographic region and an advertisement associated with the ad context. The method then generates a map associated with the geographic region, shows a marker for identifying a location in the geographic region that is associated with the advertisement. To the extent effective and amusing, this particular method of advertising is limited to the location of the user who visits the website and fails to teach or suggest a method that allows any business to attract attention of a potential customer locating within the proximity of the business location or as the customer is passing by the business location.

Hence, there is a need for an improved method and system for location based advertising system that allows any business to attract attention of a potential customer locating within the proximity of the business location or as the customer is passing by the business location. The inventive concept as set forth further below improves the aforementioned prior art systems and methods.

### SUMMARY OF THE INVENTION

A system and method of the present invention provides a unique and useful tool, i.e. a software, to users, i.e. subscribers and consumer and business owners, i.e. retailers seeking to increase sales and providing the users identify various venues such as shows, art galleries, restaurants, night clubs and any other venues where the users of similar type or interests have visited in the past or are currently visiting. The system of the present invention can be used on any type of communications devices including and not limited to mobile phones, laptops having internet connection without limiting the scope of the present invention, wherein the system may employ Global Positioning System (GPS) to generate the information regarding location located within pre-selected by the subscriber distance and range to be fed to the server.

This inventive concept allows businesses to generate revenue by attracting customers wherein the business pays per customer who actually visits their venue, not per click or per sale or per ad view as it is done in the existing market and tough by other prior art references. Any given business who uses services of the inventive concept may predict number of customers that the business wants to attract in any particular week, day, month, or year. This inventive system is web based. It is utilized by both customer, i.e. the business and the users (anyone who wants to take advantage of the system and receive discounted product such as cookie, coffee, drink, etc. The user may be charged for using the program as well. The business owner visits the website and fills out a form, where certain specific information is asked, such as name, address, contacts information of the business. After business owner or representative of the business completes this information, they will be given an option to provide number of clients they want to see per month. Then, another option is given such as duration of the services, i.e. certain number of clients per just one month or several months or even up to years.

If the business, for example, has several locations in New York and five locations in Ohio and even three locations in London, there will be option provided where the owner of the business may choose number of clients they want to see in each of the locations worldwide. This is a great tool to increase the sales specially if business is doing better in New York but sales in Ohio are falling down. The business owner will be given additional options to increase sales. If, for example, the business wants 1000 clients to be attracted per months and all these 1000 clients visited the venue within first week of the month, the inventive system will automatically “enroll” additional 1000 clients by subtracting money from the credit card of the business owner. If there are no funds available—the business owner will be informed via email, letter, or phone call. There will be an option allowing the business to “borrow customers”. For example, if the business purchased virtual coupons to attract 1000 clients for one location is New York and 1000 clients for the location in Miami and all 1000 customers visited the New York location in less than one month (assuming the business owner wants to use the inventive software for just one month or on monthly bases), the system may “borrow” 500 clients from Miami location and move them to New York location.

There are different options how the currency can be earned. It can be awarded automatically, it can be purchased, it can be exchanged between the users. For example, if the user has 1000 “virtual points” and walks along the street full of various venues such as fast food restaurant, coffee shops, a bakery store, etc., wherein all of these venues use the inventive system. The exact location of the user is known because this inventive application is running on his/her cellular phone and the location of the user is tracked by the GPS operably communicated with the controller.

Once the user comes close to the advertiser's venue, i.e. the coffee shop, a popup will display on the screen of the cellular phone with an offer from that place. For example, the offer may allow the user to convert 100 virtual points to a redeem code that can be used in the coffee shop for a cup of coffee or a cookie. Once the customer accepts the offer, the system, i.e. will deduct 100 virtual points from him/her and once it's redeemed at the coffee shop, the system will bill the coffee shop predetermined amount of money for advertising services, i.e. bringing a customer to their venue. The user/customer will never know what item his points will be applied to. The system will generate items randomly. Most likely the virtual points will be applied to.

An advantage of the present invention is to provide an improved method and system that allows any business to attract attention of a potential customer locating within the proximity of the business location or as the customer is passing by the business location by providing “virtual” coupons that appear on the screen of the mobile phone of the potential customer thereby inviting the customer to come in and redeem the “virtual” coupons for products and/or services.

Another advantage of the present invention is to provide an improved method and system that allows any business to attract attention of a potential customer locating within the proximity of the business location or as the customer is passing by providing the “virtual” coupons and informing the customer if that particular location has other people sharing the same background, interest, hobbies or visited the location or even are planning to visit location in the future.

Still another advantage of the present invention is to provide a unique method and system to allow the retailers to increase the sales specially if business has several locations wherein one of the locations generate more sales compare to the other ones and therein a need to increase overall sales of the business.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIGS. 1 and 2 illustrate a front view of a mobile phone wherein a user registers to use a system of the present invention that allows the user to visit locations that he/she prefers or try new locations that the user has not visited;

FIG. 3 illustrates a front view of a screen of the mobile phone of the user located within nearest proximity to a retail establishment, i.e. a coffee shop, wherein the screen shows an icon informing the user that the retail establishment offers a coupon with a discount on a merchandise thereby providing the user with an option to either redeem the coupon or continue to next retail establishment;

FIG. 4 illustrates a schematic view of the inventive method of the present invention;

FIG. 5 illustrates an alternative embodiment of a front view of a screen of the mobile phone of the user located within nearest proximity to a retail establishment, i.e. a coffee shop, wherein the screen shows an icon informing the user that the retail establishment offers a coupon with a discount and informing the user that the establishment has visitors that share similar interests and are the same personality type as the user; and

FIG. 6 illustrates a diagram of various components of the inventive system operably communicating with one another to facilitate inventive method for allowing the retail establishments to attract attention of the user thereby allowing the user to visit establishments that he/she prefers or try new locations that the user has not visited

### DETAILED DESCRIPTION OF THE INVENTION

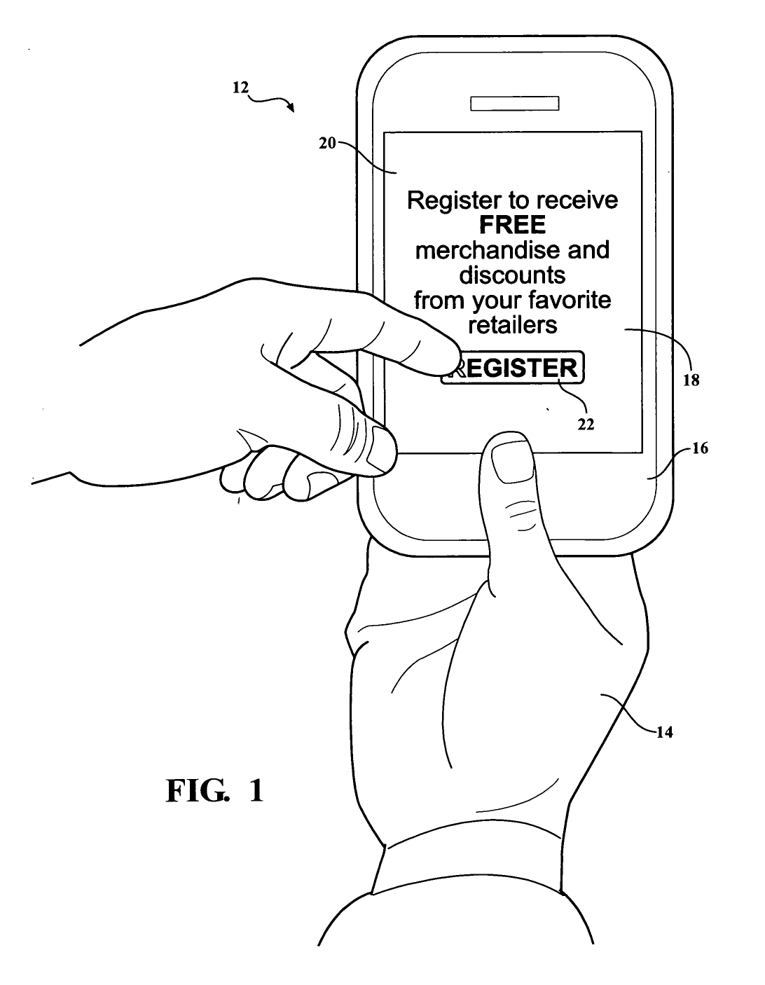

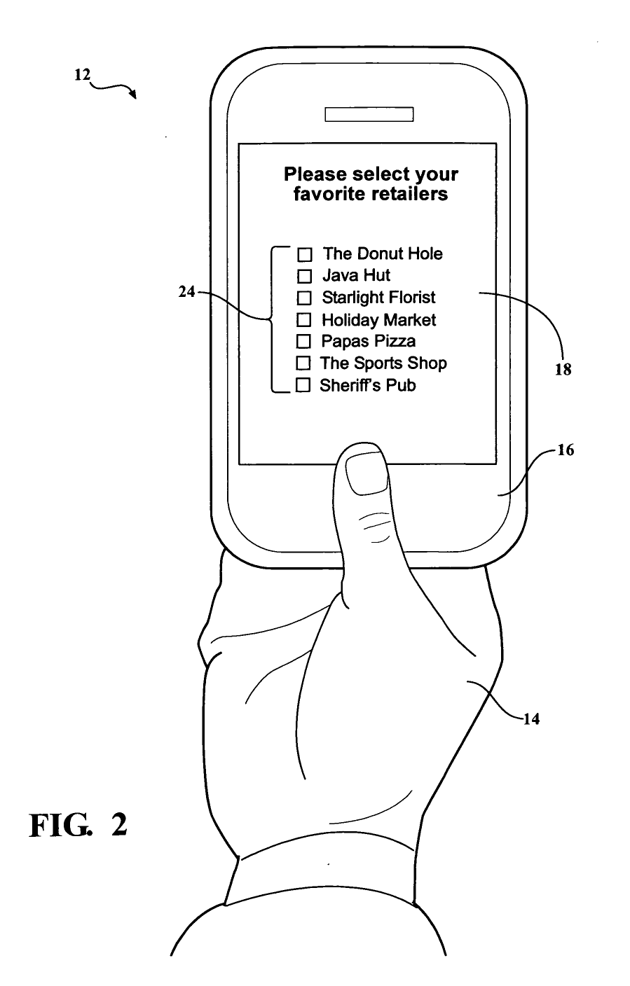

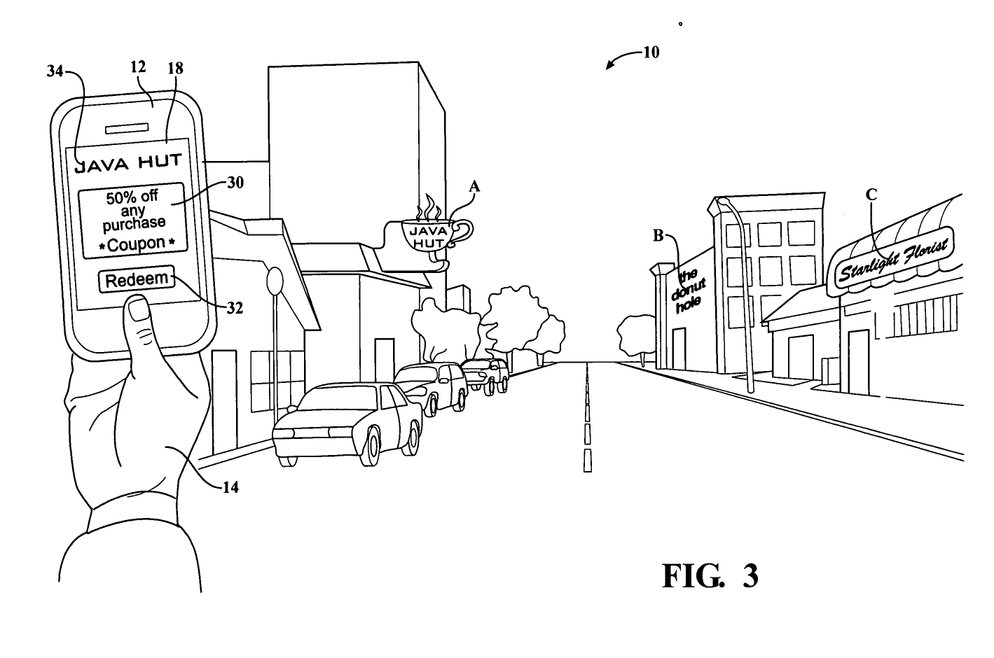

Referring to the Figure, wherein like numerals indicate like or corresponding parts throughout the several views, a system, generally shown at 10 in FIGS. 3 through 6, for providing social networking between users subscribing to the system from communication devices, such as, for example mobile or cellular phones, generally shown at 12 in FIGS. 1 and 2.

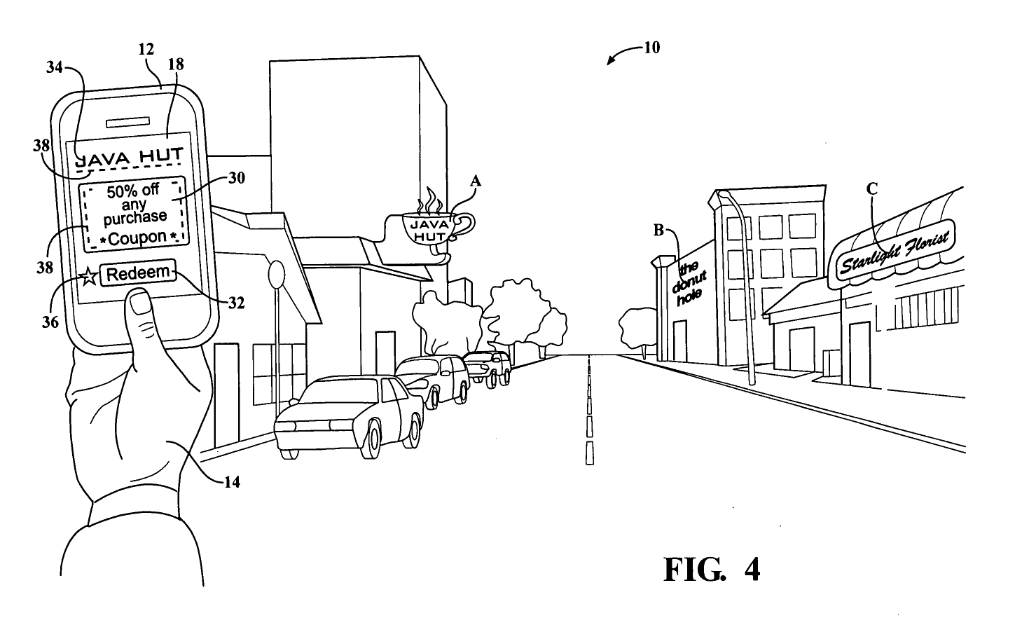

The system 10 and method of the present invention provides a unique and useful tool to users/subscribers 14 seeking to identify various venues such as shows, art galleries, restaurants, night clubs and any other venues where the users of similar type or interests have visited in the past or are currently visiting. FIGS. 3 and 4 show various venues, i.e. retail establishments such as a coffee shop, a donut shop, or a flower shop at A, B, and C, respectively. Other establishments such as food, cloth, show, electronic, auto, and many other retailers not shown in FIGS. 3 and 4, may utilize the inventive concept of the system 10 without limiting the scope of the present invention.

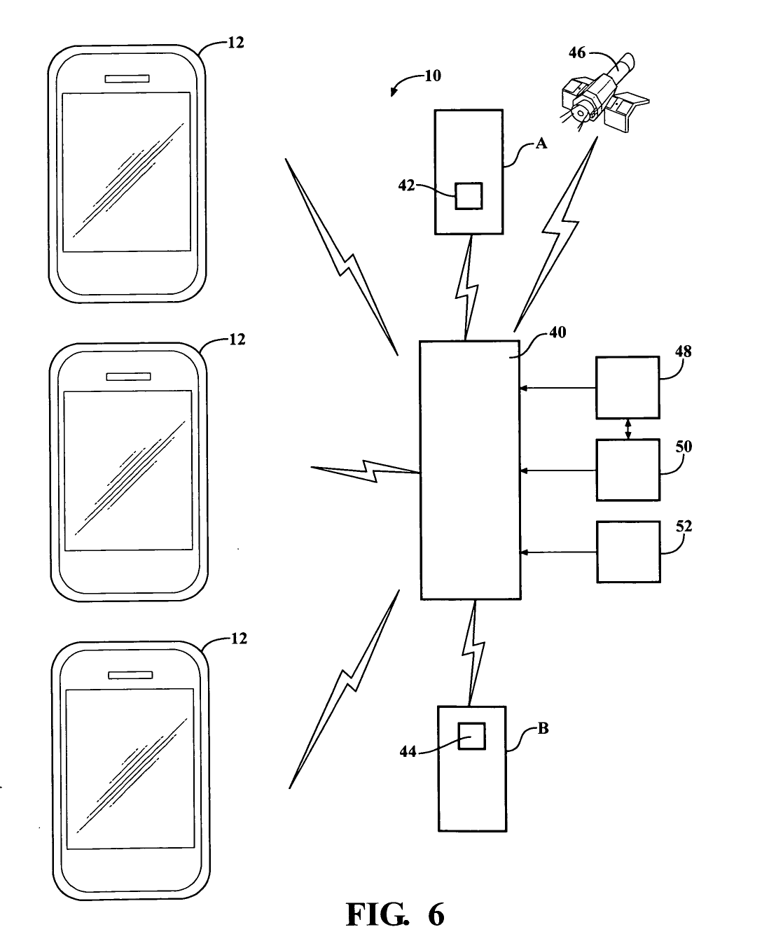

The system 10 of the present invention can be used on any type of communications devices including and not limited to cell or cellular phones 12, mobile phones, laptops, cash registers located at the establishments, and all other communications devices having internet connection without limiting the scope of the present invention, wherein the system 10 may employ Global Positioning System (GPS), shown in FIG. 6, to generate the information regarding location of the user 14 relative the establishments A, B, or C. The subscriber 14 may also be referred to as the user or the consumer throughout the description of the inventive concept without limiting the scope of the present invention.

By way of illustration and without limiting the scope of the present invention, the communication and computing device may be a standalone device such as a desktop computer or laptop computer, or it may be a communications device such as the cellular phone 12, a pager, a personal data assistant, a transponder, a radio, a walkie-talkie, or other mobile device that may communicate via network and without limiting the scope of the present invention. The computing device interacts with client via graphical user interface (GUI). As best shown in FIGS. 1 through 4, the cellular phone 12 may utilize an input device such as a touch screen 18 to present the user various messages such as informing the user to register with the system to receive free merchandise and discounts, as shown at 20, a register option 22, a list of various retailers 24 that subscribed to the system 10, a name of the retailer 34 that appears on the screen 18, and the user 14 is proximate the retailer's establishment A, as shown in FIGS. 3 and 4, a redeem button 32, and a virtual coupon 30. Other modifications, designs, and formats of the messages that appear on the screen 18 may be used without limiting the scope of the present invention. Numerous numerical and non-numerical symbols and signs and combination thereof are used by the system 10 to inform the users 14 about discounts that can be redeemed by the users 14 at the retailer's establishments without limiting the scope of the present invention.

As best illustrated in FIG. 6, the system 10 for advertising the goods and services provided by the retailers A, B, and C to the consumers 14 communicating with one another through a network. A controller 40, the cellular phones 12 of the consumers 14, and the communication devices 42 and 44 of the retailers A and B are communicated with the controller 40. The global positioning system 46 is operably communicated with the controller 40 to determine location of the consumer 14 relative the location of the retailer. A program, i.e. a software 48 of the controller 40 is adaptable to receive information associated with the goods and services from the retailer. The program 48 assigns an identifier to the goods and services to present the identifier to the consumer through the cellular phone 12 as the global positioning system 46 determines location of the consumer 14 relative the location of the retailer thereby providing the consumer 14 with option to redeem 32 the identifier, i.e. the virtual coupon 30 for at least one of the goods and services at the location of the retailer, as shown at A in FIG. 3. The controller 40 of the system 10 includes an information processor 50, a subscriber record data store 52, and other components (not shown) such as a communications system, a subscriber display manager, a subscriber input manager, a subscriber login manager, and a matching data manager.

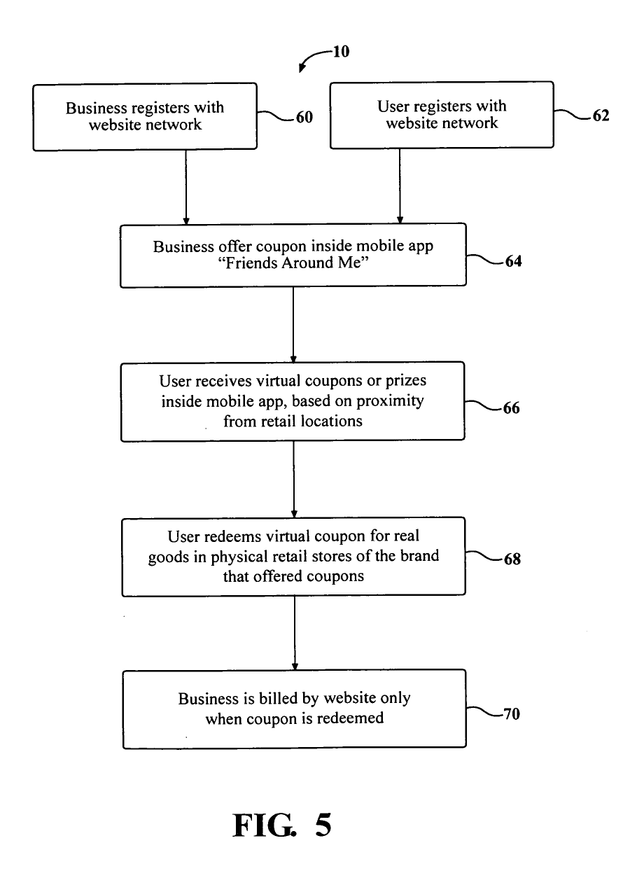

This inventive concept allows various businesses to generate revenue by attracting the customers 14 wherein the business pays per customer who actually visits their venue, not per click or per sale or per ad view as it is done in the existing market. Any given business who uses services of the inventive concept may predict number of customers the business wants to attract in any particular week, day, month, or year. This inventive system is web based. As best shown FIG. 5, the inventive method of the system 10 begins with business or retailer registering 60 with the system 10. The users also register with the system 10 as shown at 62. The business offers various virtual coupons inside mobile application as shown at 61. For example, the coupons may have different names, such as “Friends Around Me” or “FAM”, without limiting the scope of the present invention. As the user 14 passes about the retailer, the user 14 will receive the “virtual” coupons 30 or prizes inside the mobile application, as best shown in FIGS. 3 and 4. The user 14 then redeems the “virtual coupons” 30 for real goods or services in the retailer's location 68 for the brand that offered the “virtual” coupon 30. The retailer is billed 70 by the system 10, i.e. the website only when the “virtual” coupon is redeemed.

The inventive system is utilized by both the customer (i.e. the business such as, for example coffee shop or any other retailer) and the user 14 (anyone who wants to take advantage of the system 10 and receive discounted product such as cookie, coffee, drink, etc. The user 14 may be charged for using the program as well.

Alluding to the above and referring back to FIG. 5, the business owner visits the website and fills out a form, where certain specific information is asked, such as name, address, contact information of the business, credit or debit card information for payment of services. After business owner or representative completes this information, they will be given an option to provide number of potential clients they want to see per month. Then, another option is given such as duration of the services, i.e. certain number of clients per just one month or several months or even up to years. If the business has several locations, such as, for example, three locations in New York and five locations in Ohio and even three locations in London, there will be the option provided where the owner of the business may choose number of potential clients they want to see in each of the locations worldwide. This inventive system 10 presents a great tool to increase the sales specially if business generates more sales in New York locations of the business but sales in Ohio are falling down.

Alluding to the above, the business owner will be given an option to add additional number of potential. The business may be charged a fee, such as signing or membership fee payable to the system 10 in order to use advertising services of the system 10. If, for example, the business bought 1000 clients to be attracted per months and all these 1000 clients visited the venue within first week of the month, the inventive system will automatically “enroll” additional 1000 clients by subtracting money from the credit card of the business. If there are no funds available—the business owner will be informed via email, letter, or phone call. The business will be billed only when the “virtual coupons” 30 are redeemed at the location.

The system 10 has additional option to allow the business to add additional customers. For example, if the business purchased 1000 clients or the “virtual coupons” 30 for one location is New York and 1000 clients or the “virtual coupons” 30 for the location in Miami and all 1000 customers visited the New York location in less than one month (assuming the business owner wants to use the inventive software 48 for just one month or on monthly bases), the system 10 may “borrow” 500 clients or the “virtual coupons” 30 from Miami location and move them to New York location.

The users 14 will earn “virtual” currency to redeem the “virtual” currency or tokens in exchange for the “virtual coupons” 30. There are different options how the currency can be earned. It can be awarded automatically, it can be purchased, it can be exchanged between the users 14. For example, if the user 14 has 1000 of the virtual currency and walks along the street full of various venues such as A, B, and C, as illustrated in FIGS. 3 and 4, whereby all these venues use the inventive system 10, the exact location of the user 14 is known because this application is running on his cellular phone 12. Once the user 14 comes close to the advertiser's venue A, as shown in FIGS. 3 and 4, the popup 30 will display on the screen 18 with an offer from that place. The offer may invite the user 14 to convert 100 of his/her “virtual” currency or points to a redeem code 32 that can be used in the establishment A for a cup of coffee. Once the user 14 accepts the offer, the system 10 deducts 100 “virtual” points from the user's 14 account and once it's redeemed in the establishment A, the system 10 charges the business the predetermined amount of money agreed earlier with the business (for bringing a customer to their venue). The user 14 will never know what item his points will be applied to. The system 10 will generate items randomly.

FIG. 4 shows alternative embodiment of the present invention. As the subscriber 14 registers with the system 10, as shown at step 62 in FIG. 5, the subscriber 14 records data store have a program includes a subscriber profile for each subscriber associated with a subscriber identifier. The program includes a plurality of questions designed to receive characteristic data and preference data from the subscriber 14. The characteristic data may include and is not limited to age, marital status, physical size, physical limitations, religion, sexual orientation, how person feels, and similar personal information, weather person is romantic, rational, dreamer, etc.

Alluding to the above, the potential subscriber 14 will be asked questions about his/her preference in food, clothing, sports, entertainment, and music, and information that determines at least in part how the subscriber interacts with other subscribers. The subscriber 14 then will be assigned a predetermined identifier represents a certain type of the personality of the subscriber. For example, every subscriber who likes classical music, non spicy food, does like extreme sports but instead prefers playing chess and the like will be assigned or categorized as identifier type 1. Every subscriber who prefers spice food, extreme sports, and extreme fashion will be assigned or categorized as identifier type 2. Each identifier will be assigned a certain color.

Referring now back to FIG. 4, as the user 14 comes close to the advertiser's venue A, i.e. the coffee shop, the popup 30 will display on the screen 18 with an offer from that place. The offer may invite the user 14 to convert 100 of his/her “virtual” currency or points to the redeem code 32 that can be used in the establishment A for a cup of coffee. Once the user 14 accepts the offer, the system 10 deducts 100 “virtual” points from the user's 14 account and once it's redeemed in the establishment A, the system 10 charges the business the predetermined amount of money agreed earlier with the business (for bringing a customer to their venue). The user 14 will never know what item his points will be applied to. The system 10 will generate items randomly. In addition, if the user 14 is determined by the system 10 to be the identifier type 2, i.e. the person who prefers spice food, extreme sports, and extreme fashion and is assigned, for example, “green” color code, a sign, such as “green star” 36 will appear on the screen 18 and the “virtual coupon” 30 and the name of the establishment 34 will be eliminated or presented in a green color as shown at 38 in FIG. 4. This feature will allow attracting the user 14 to visit the establishment A even if the user 14 is not interested to receive discounted goods or services but would be willing to do it anyway if the user 14 can meet others who have the same type of personality.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims

1. A system for advertising goods and services provided by retailers to consumers with the retailers and the consumers electronically communicating with one another through a network, said system comprising:
a controller of said system;
a first communication device of the consumer communicated with said controller;
a second communication device of the retailer communicated with said controller and said first communication device;
a global positioning system operably communicated with said controller to determine location of the consumer relative the location of the retailer; and
a program of said controller adaptable to receive information associated with at least one of the goods and services from the retailer and assign an identifier to at least one of the goods and services to present said identifier to the consumer through the first communication device as said global positioning system determines location of the consumer relative the location of the retailer thereby providing the consumer with option to redeem said identifier for at least one of the goods and services at the location of the retailer.

2. A system as set forth in claim 1, wherein identifier is represented by at least one of numerical signs, non-numerical signs, and combination thereof.

3. A system as set forth in claim 2, wherein said identifier is represented by colors.

4. A system as set forth in claim 3, wherein said identifier is a coupon to be redeemed for discounted goods and services.

5. A system as set forth in claim 3, wherein said identifier is a prize to be exchanged for at least one of the goods and services.

6. A system as set forth in claim 4, wherein said first and second communication devices includes at least one of a desktop computer, a laptop computer, a mobile phone.

7. A system as set forth in claim 4, wherein said second communication device is further defined by a cash register.

8. A system as set forth in claim 6, wherein said program of said controller is adaptable to receive information associated with at least one of the goods and services from the retailer and assign said identifier to at least one of the goods and services wherein said identifier presents discounted price of the goods and services predetermined by the retailer.

9. A system as set forth in claim 1, wherein said system connects the consumers and the retailers with each other by a network including at least one of a wired network, a wireless network, and a fiber network.

10. A system as set forth in claim 7, including a second program of said controller communicated with said second communication device wherein said second program of said controller bills the retailer for advertising services provided through said system as the consumer redeems said identifier for at least one of the goods and services at the location of the retailer.

11. A method for advertising goods and services provided by retailers to consumers with the retailers and the consumers electronically communicating with one another through a networks, said method comprising the steps of:
connecting a controller of the system with a first communication device of the consumer;
connecting a second communication device of the retailer with the controller and the first communication device;
connecting a global positioning system with the controller to determine location of the consumer relative the location of the retailer;
connecting a program to the controller to receive information associated with at least one of the goods and services from the retailer; and
assigning an identifier to at least one of the goods and services to present thereby presenting the identifier to the consumer through the first communication device as the global positioning system determines location of the consumer relative the location of the retailer providing the consumer with option to redeem the identifier for at least one of the goods and services at the location of the retailer.

12. A method as set forth in claim 11, wherein the step of assigning identifier is further defined by representing the identifier by at least one of numerical signs, non-numerical signs, and combination thereof.

13. A method as set forth in claim 12, wherein the step of assigning identifier is further defined by representing the identifier by colors.

14. A method as set forth in claim 13, wherein the step of assigning identifier is further defined generating a coupon to be redeemed for discounted goods and services.

15. A method as set forth in claim 13, wherein the step of assigning identifier is further defined generating a prize to be exchanged for at least one of the goods and services.

16. A method as set forth in claim 14, wherein said first and second communication devices includes at least one of a desktop computer, a laptop computer, a mobile phone.

17. A method as set forth in claim 11, including the step of connecting the consumers and the retailers with each other by a network including at least one of a wired network, a wireless network, and a fiber network.

18. A method as set forth in claim 17, including the step of connecting a second program to the second communication device and the controller to bills the retailer for advertising services provided through the system as the consumer redeems the identifier for at least one of the goods and services at the location of the retailer.

19. A method as set forth in claim 18 wherein the step of connecting the program to the controller is further defined by receiving information associated with at least one of the goods and services from the retailer and assigning the identifier to at least one of the goods and services wherein the identifier presents discounted price of the goods and services predetermined by the retailer.

20. (canceled)

21. (canceled)

22. (canceled)

23. (canceled)

24. (canceled)

25. (canceled)

26. (canceled)

27. (canceled)

28. (canceled)

29. (canceled)

30. (canceled)
